(19) United States
(12) Patent Application Publication
(10) Pub. No.: US 2013/0162690 A1
(43) Pub. Date: Jun. 27, 2013

(54) Breakover Conduction Driving Method

(71) Applicant: Robert G. Marcotte, New Paltz, NY (US)

(72) Inventor: Robert G. Marcotte, New Paltz, NY (US)

(73) Assignee: Robert G Marcotte

(21) Appl. No.: 13/338,189

(22) Filed: Dec. 27, 2011

(51) Int. Cl. G09G 3/28; G09G 5/10

(52) U.S. Cl. 345/690; 345/60

(57) ABSTRACT

A device operating in accordance with the invention receives data respective of an image to be displayed, determines the illumination load requirement for at least one illumination period according to the image data and adjusts the operation of the illumination driver according to the illumination load requirement such that a driving current is maintained between an electrode charging phase and an illumination phase according to the illumination load requirement. The invention seeks to negate the driving electrode inductance between the driving circuit and the load by maintaining an electrical current within the driving electrode between the charging phase and the conductive phase.

### BACKGROUND OF THE INVENTION

1. Field of the Invention

The present invention relates to the operation of gas discharge and other breakover conduction elements used within illumination and display devices providing circuits and methods for anticipating a current draw and while applying a pulse, maintaining a current flow through an electrode between charging and conductivity phases to mitigate inductive effects caused by large current flows during the conductivity phase which are impeded by electrode inductance.

2. Description of the Related Art

Breakover conduction elements are well known in the field of electronics and include gas discharge devices and solid state devices. A breakover conduction element typically has at least two terminals with a breakover voltage thereacross. In an OFF state, a breakover conduction element has high impedance and exhibits a capacitive characteristic. Upon exceeding a breakover voltage characteristic, the breakover conduction element transitions to a highly conductive low impedance ON state. A breakover conduction element remains conductive until a voltage thereacross is removed and/or a current therethrough is removed; typically both. A gas discharge device, such as a fluorescent lamp or plasma display illumination cell, or an AC diode (DIAC) has two terminals and a predetermined breakover conduction voltage there between. The breakover conduction element within gas discharge device is a dischargeable gas comprising at least one of helium, neon, argon, xenon, krypton, mercury and sodium.

In a three electrode surface discharge plasma display panel (PDP), each illumination cell has three terminals; two sustain terminals and an addressing terminal. Each terminal is typically coated by a dielectric, and therefore has capacitance wherein wall charges indicative of a memory state are set. The sustain terminal dielectric coatings are exposed to a dischargeable gas which has high impedance and exhibits a capacitive characteristic. Upon exceeding a breakover voltage characteristic, the dischargeable gas becomes conductive and rapidly forms a plasma discharge. As current flows through the plasma discharge, electrical charge is transferred between the dielectric surfaces covering the terminals and molecular and atomic excitation yields the emission of visible and/or ultraviolet light photons. Adjacent to the plasma discharge, a phosphor material may convert ultraviolet photons to visible light. Coating the dielectric surfaces with a protective layer comprising at least one of; MgO, CaO, BaO, SrO or other suitable material aids in lowering the breakover voltage and reducing the gas discharge formation time. As the electrical charge is transferred between dielectric surfaces, the voltage across dischargeable gas falls to zero, the current flow ends and the dischargeable gas returns to a high impedance state. Thus, the breakover conduction element, i.e. the dischargeable gas, has high impedance, transitions to low impedance when the applied voltage thereacross exceeds a predetermined breakover conduction voltage of the dischargeable gas, and, once the charge is transferred, the voltage thereacross and the current therethrough decreases and falls below a predetermined threshold, and transitions to the high impedance state.

Additionally, some breakover conduction elements, such as a silicon controlled rectifier or a plasma display illumination cell, have a third terminal referred to as a trigger terminal or addressing terminal. In using these devices, a voltage is typically applied across the main terminals while the device is in the OFF state. When sufficient voltage is applied to the third terminal, in reference to one of the main terminals, conductivity may be induced and the element switches into the ON state and behaves as previously described. During addressing operations within a PDP, a voltage is applied across sustain electrodes close to the breakover voltage. Thus, applying a data pulse to selected column electrodes is sufficient to trigger the breakover conduction (i.e. gas discharge) necessary to set ON state wall charges.

In a large area display device, illumination cells are disposed at intersecting points of row and column driving electrodes. Long electrodes, coupling the illumination cells to a driving circuit, have additional resistive and inductive characteristics as described in U.S. Patent Application 61/476,382, herein incorporated by reference. Large electrode inductances present a problem in that under prior art driving conditions; long, parallel and magnetically coupled driving electrodes exhibit inductance due to pulsed currents flowing in a common direction. As voltage is applied across breakover conduction cells (discharge cell, memory cell, illumination cell, etc.), exceeding the breakover voltage of the dischargeable element, conduction initiates so rapidly that the voltage across the cell terminals drops sharply as instantaneous current flow is impeded by the inductance of the driving electrodes. As the voltage droops, the conduction is reduced. Albeit in a short period of time, the driving electrode current increases relatively slowly to supply the current requirement of the cell or plurality of cells in the ON state.

In a prior art circuit topology illustrated in FIG. 1, a pair of resonant driving circuits produce output waveforms SA and SB to drive respective electrodes of display 140. Driving signals S1-S4 operate switches S1-S4 respectively of resonant driving circuit 120 to produce output waveform SA under a zero load condition. Under this condition, resonant current pulse 101 flows through resonant inductor Ler, through the coupling capacitance Ce of display 140 and is returned through the opposing resonant driving circuit 130. Resonant driving circuit 130 is held a constant potential during the operation shown. The value of inductance Ler is chosen to limit the rise time of output SA between times t1-t3 and determines the amplitude of current pulse 102. During operation, S1 closes at time t1 to apply voltage Ver to inductance Ler and current I101 (and therefore I102) begins increasing. At time t2, the voltage of output SA equals voltage Ver and current I101 (and therefore I102) peaks at this moment. Between times t2-t3 the voltage of output SA increases to voltage Vr as the current flow diminishes, reaching zero at time t3. At time t3, a small reverse current (not shown) is induced by the output voltage SA being greater than voltage Ver. This reverse current is momentary and limited as diode D1 becomes reversed biased. Also at time t3, switch S3 is closed to apply the voltage Vs to output SA, producing the small current pulse subsequent to time t3 shown on waveform I102 thus completing the resonant charging phase. Without any pixels being illuminated, there is no conductive phase following the application of voltage Vs.

FIG. 2 shows a circuit model for a surface discharge AC plasma display wherein row electrodes E1 and E2 form a row of pixels. Each electrode has distributed resistances Re and distributed inductances Le. Electrode E1 is driven from the left side, and E2 is driven from the right side. As voltage is applied to electrode E1, the current flow is distributed as currents I1 and I2 returns through electrode E2. The effective inductance is thus the sum of inductances Le and the effective resistance is the sum of resistances Re. Along the row of pixels, electrodes E1 and E2 are coupled by distributed capacitances Ce. Address electrodes and barrier ribs (not shown), orthogonal to row electrode pairs, divide each row into a plurality of addressable discharge cells. Each discharge cell 205 comprises a dielectric barrier covering electrode E1, the dischargeable gas, and a dielectric barrier covering electrode E2 to form a capacitance in series with a breakover conduction element. As an electrical element 205, the dischargeable gas has a breakover conduction characteristic. Once a breakover voltage is reached, the device becomes highly conductive and will remain conductive until its current flow falls below a threshold. With the dielectric barrier covering the electrodes, wall charges build up on the dielectric surfaces as the voltage across the gas diminishes. Once the dielectric surface is charged, the discharge self-extinguishes. The wall charge is indicative of memory state. Thus, electrical element 205 is a memory based breakover illumination cell.

FIG. 3 shows an illustration of the electrode current I102 in response to applying voltage SA from FIG. 1 to electrode E1 and the voltage Vp which results at the terminating (far right) end of electrode E1. During the electrode charging phase, times t1-t3, voltage Vp rises as current pulse I103 of current I102 flows into electrode E1, charges the distributed capacitances Ce from 0V to Vs, and exits through electrode E2. At time t3, the voltage across the dischargeable element (gas or DIAC) reaches the breakover conduction point, and the illumination discharge is triggered. At time, t3, the resonant driver current, I102 is reaching zero and momentarily reverses current between times t3 and t4 as the output switch S3 closes to apply voltage Vs. While the illumination discharge forms between time t3 and t4, the distributed electrode inductances Le exhibit high impedance due to the negligible, or reverse, current flow. Thus, conductivity phase current must be drawn locally through the distributed capacitances Ce and the voltage Vp at the end of electrode E1, droops to voltage Vdroop. The voltage difference across the electorde, i.e. Vs-Vdroop, applies a forcing voltage to the electrode's distributed inductances Le, and current pulse I104 begins to flow proportional to the droop voltage Vdroop, time and the electrode inductance (i.e. VT/L). Thus, the voltage Vs-Vdroop over the time t3-t5 induces current pulse I104. The electrode inductances and resistances limit the discharge current I104 between times t4 and t5. It is not until time t5, after the discharge completes, that the electrode voltage reaches, and often overshoots, the applied voltage Vs.

The substantial voltage drops along electrodes E1 and E2 reduce the current peak I104, slowing the discharge at each pixel. In a gas discharge device, the efficacy of a gas discharge is reduced by the impeded current flow, the brightness is reduced, and the brightness becomes non-uniform across the gas discharge device's illumination area. Thus, there is a need for reducing inductive effects presented by the current requirements of breakover conduction elements.

### SUMMARY OF THE INVENTION

The invention contained herein provides circuits and operating methods that address the aforementioned problems. FIG. 4 illustrates the driving method of the invention. In a first step, a display operating in accordance with the invention receives data respective of an image to be displayed. In a second step, the display determines the illumination load requirement for at least one illumination period according to the image data. In a third step, the display modulates timing and/or voltage to adjust the operation of the illumination driver according to the illumination load requirement such that a driving current is maintained between an electrode charging phase and an illumination phase according to the illumination load requirement. The invention provides driving circuits and methods for driving a data dependent load which, during the application of a voltage pulse, may be characterized as having; a capacitive characteristic during a charging phase and a conductive characteristic after exceeding a breakover conduction voltage. The invention seeks to negate the driving electrode inductance between the driving circuit and the load by maintaining an electrical current within the driving electrode between the charging phase and the conductive phase.

As is well known in the art, PDPs are operated using a subfield driving method wherein an image frame is divided into brightness weighted illumination periods. In other display technologies, a field sequential driving method divides an image frame into color specific illumination periods. Regardless of the driving method, each illumination period has an illumination requirement based upon number of light emitting elements being illuminated such that the accumulated illumination of all the illumination periods within a frame time corresponds to the desired image. Emissive technologies such as PDPs and LEDs and OLEDs arrays, have a current requirement based upon the illumination requirement and the area of the light emitting element.

For a memory based illumination technology, such as a PDP, a subfield contains at least, an addressing period and an illumination period. During the addressing period, each row electrode coupled to a plurality of cells is selected, and wall charges are set (ON or OFF) indicative of each cell's illumination requirement for the respective subfield. During the illumination period, only cells bearing wall charges are illuminated by illumination pulses. Since the illumination power is proportional to the number of cells being illuminated, the illumination load requirement for each subfield is determined by accumulating the number of cells to be illuminated and thus a loading ratio or value for each subfield may be anticipated and the operation of the driving circuit may be modulated according to the anticipated current draw. Thus, the conductivity phase current can be induced before the conductivity phase current draw begins, allowing full conductivity to occur sooner.

According to the invention, a controller anticipates an illumination load as the image data is received and arranged into subfield data. Subsequently, the illumination load value is utilized within respective illumination periods to alter the operation of the driver circuit; either by controlling voltages, timing or both. The driving circuit applies a current pulse for charging the display's electrode capacitance to the breakover conduction voltage with excess energy such that a current flow can be maintained between the charging phase and the conduction phase according to the anticipated current draw, with greater energy than is required to charge the electrode capacitance to the desired operating voltage. The excess energy (i.e. current) is thus available to minimize the initial voltage droop of the conduction phase, while not overshooting the desired operating voltage at the completion of applying the pulse.

Although the invention is widely applicable, the description contained herein presents embodiments of the invention described in reference to multi-electrode dielectric barrier discharge devices used for illumination and addressable matrix gas discharge devices, such as PDPs. Large area PDP's benefit from the methods contained herein due to their large electrode capacitance, high discharge current, variable load and large electrode inductance.

In a first embodiment of the invention, a controller anticipates an expected current draw and, according to the expected load, modulates the output switch timing of the resonant driving circuit topology of FIG. 1. Using an illumination load value derived from the received image data, a timing controller advances the turn-on timing of the driving circuit's output switch S3. During the resonant electrode charging phase, the circuit applies a voltage to the resonant inductance Ler to induce the prior art charging current 101. Under minimal load, the closing of switch S3 occurs at approximately the same time as current 101 returns to zero, as in the prior art. According to the invention, as the illumination load increases, the timing of output switch S3 is advanced to apply the output voltage Vs to maintain a current flow between an electrode charging phase and an illumination phase of each pulse. Thus, illumination along the electrode occurs while a current flow is maintained within the electrode, according to the expected load such that the application of excess energy is prevented.

In a second embodiment of the invention, the functionality of the resonant driving circuit topology of FIG. 1 is augmented with a circuit comprising an additional voltage source coupled to a switch and to a second inductor. Utilizing the illumination load value to modulate the voltage source and/or the switch timing, supplemental energy is applied during the charging phase to be consumed by the load during the load's conduction phase.

A third embodiment applies the invention to a multi-phase resonant driving circuit, wherein the aforementioned second embodiment may be employed. In this embodiment, the charging phase comprises two concurrent charging phases and two concurrent conduction phases wherein reciprocal current flows produce canceling magnetic fields to reduce the electrode inductance. The lowered inductance enables higher and faster currents during the conductivity phase. In a PDP, these improvements exhibit increased brightness and efficacy.

### BRIEF DESCRIPTION OF THE DRAWINGS

FIG. 1 illustrates a prior art resonant driving circuit

FIG. 2 illustrates an electrode model for a surface discharge PDP.

FIG. 3 illustrates the voltage droop of prior art driving methods

FIG. 4 illustrates a flow chart describing the method of the invention

FIG. 5 illustrates maintaining an electrode current between a charging phase and a conduction phase.

FIG. 6 illustrates an operation of the invention on the prior art topology of FIG. 1 using time modulation according to an anticipated loading level.

FIG. 7 illustrates a resonant driving circuit according to the invention.

FIG. 8 illustrates a second resonant driving circuit according to the invention.

FIG. 9 illustrates a third resonant driving circuit according to the invention.

### DESCRIPTION OF THE INVENTION

FIG. 5 illustrates operation of the electrode structure from FIG. 2, according to the methods of the invention. Over the time period t1 to t5, a current pulse I102 is applied to electrode E1 comprising charging component I101 and a conduction component I530. Waveform Vp illustrates the voltage at the end of electrode E1. In combination with ON state wall charges, voltage Vs is greater than the breakover voltage Vbr of cell 205 and represents the desired output voltage. At a time t1, the resonant driving circuit 120 (S1, D1, Ler) applies the first current pulse portion I101 to charge the distributed electrode capacitances Ce during time period t1-t3 from zero volts to the sustain voltage Vs. The driving circuit provides an anticipated current pulse portion 1530 through a portion of the charging phase t1-t3 and, into the conduction phase t3-t5, such that current flow is maintained (designated as I101+I530) and sufficient to supply at least a portion of the accumulated current draw I104. Note that during the time t2-t4, the slope of current pulse I102 is flat, i.e. the di/dt=0, substantially eliminating the inductive voltage drop component of Vdroop and therefore, the droop voltage Vdroop becomes predominantly resistive. Note that the amplitude of the conductivity phase current pulse I104 is determined by the image data and proportional to the number of cells being illuminated. Thus, current pulse I530 is to be controlled according to an illumination load value derived from the image data.

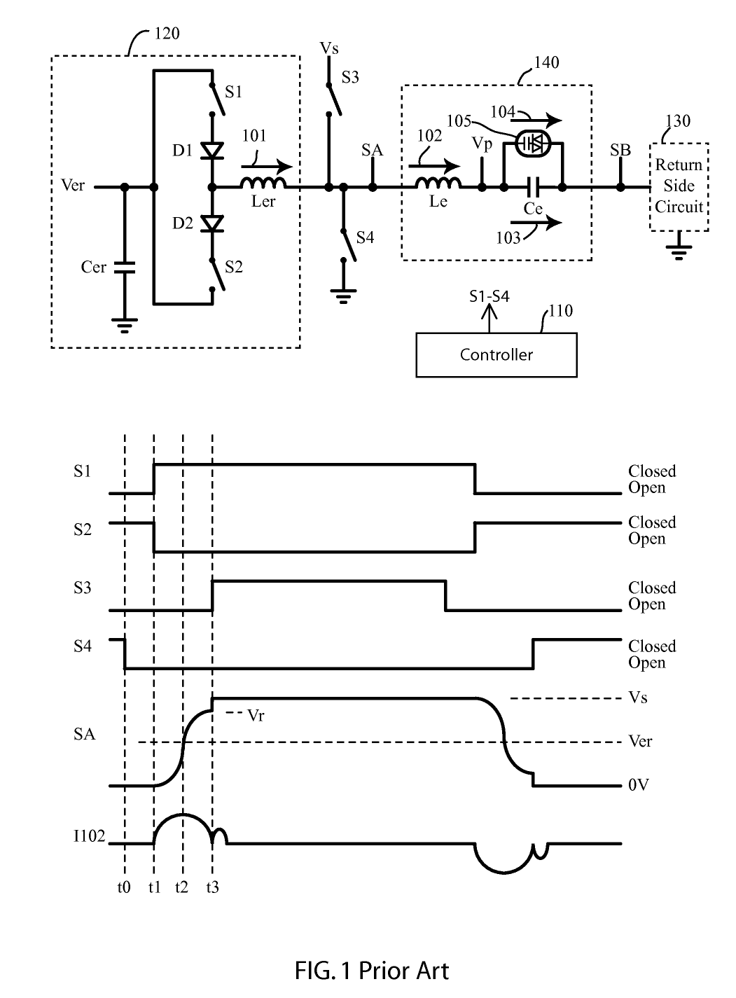

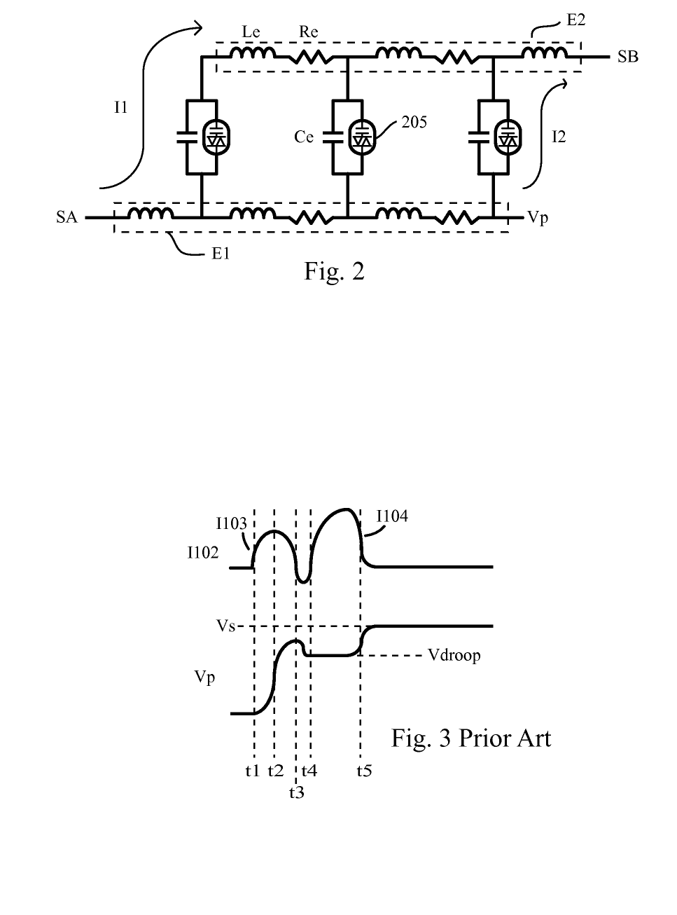

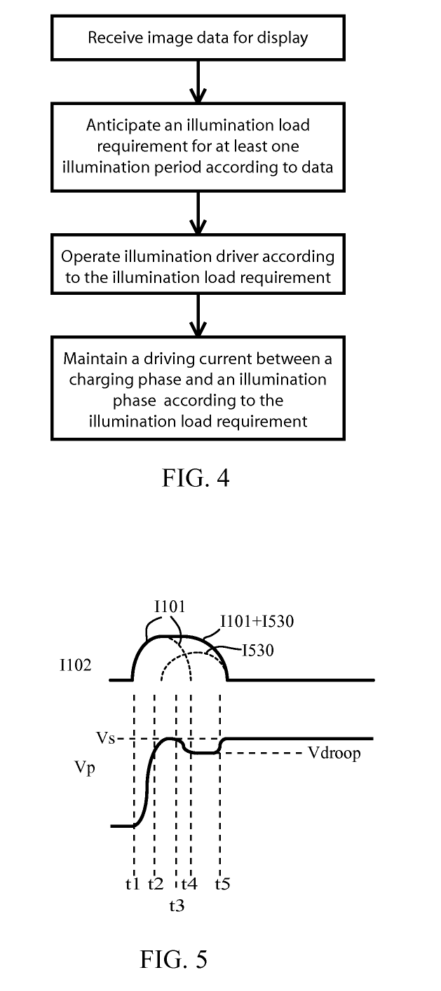

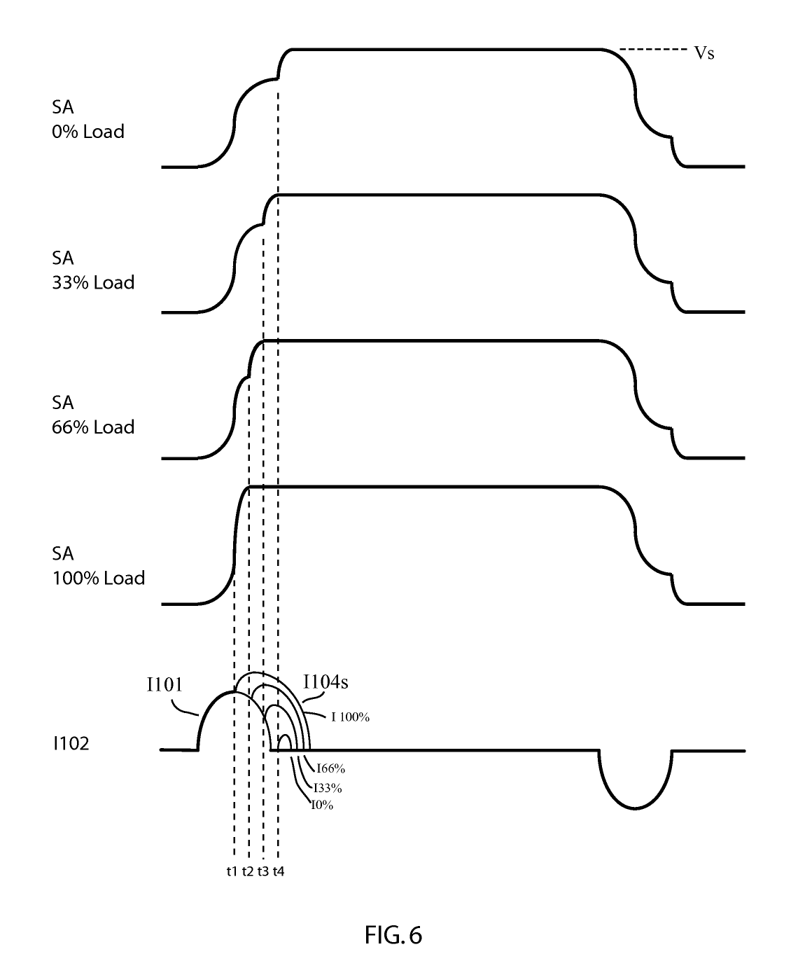

FIG. 6 illustrates operating the topology of FIG. 1 according to the invention under a variety of load conditions. Specifically, output SA waveforms are shown for proportions of 0% (all pixels off), 33%, 66% and 100% (all pixels illuminated) of cells being discharged. Current waveform I102 illustrates the overlap of the charging phase current pulse I101 and a combined pull-up and conductivity phase component I104 for each loading condition (i.e. the plurality I104s) I0%, I330%, I66%, and I100% for each respective loading condition. Times t1-t4 illustrate the timing of closing switch S3, with closure occurring at t4, t3, t2 and t1 for loading conditions 0%, 33%, 66% and 100% respectively. As can be seen in the illustration, as the closure of switch S3 is advanced (made earlier) from time t4 to t1, the output voltage SA is pulled to sustain voltage Vs up by switch S3 at earlier times, while the resonant charging current pulse I101 is substantially maintained. Referring to the current pulse waveform I102 and top SA waveform driving a 0% load, the turn-on timing of FIG. 1 switch S3 occurs at time t4 (same as time t3 of FIG. 1). Thus under 0% load, the current I101 provides the substantial charging of output SA to voltage Vr and current I10% is supplied by switch S1 to pull output SA up to voltage Vs. As the turn-on timing of switch S3 advances (earlier) from t4 to t1, output SA pulls up to voltage Vs earlier and the corresponding pull-up currents I33%, I66% and I100% increase. Referring to the current pulse waveform I102 and SA waveform at 100% load, the cumulative current I102 varies with time, reaching a resonant charging current I101 peak at time t1 coincidentally concurrent with the start of the 100% load pull-up current I104I100% supplied by switch S3. It should be noted that the waveforms shown are at the driving end of the electrodes receiving the signal. Fast turn-on of switch S3 applies voltage Vs to the accumulated electrode inductances Le and thus applying a forcing voltage to the electrode inductance and thus the current I104 increases to a peak and is maintained by the electrode inductances time that output SA reaches voltage Vs. Consequently, as the voltage across the illumination cell is driven above the breakover voltage of the dischargeable gas, the high speed breakover currents (i.e. gas discharge currents) flow freely, minimizing the voltage droop at the cells being discharged. At time t2, the electrode voltage SA equals supply voltage Vs, and the charging phase is concluded. Subsequently, between times t2-t5, the voltage across the illumination cells is driven above the breakover conduction voltage and current flows through the illumination cells as the illumination occurs. As the illumination cell capacitance is charged, the current decrease to zero. Thus, the current flow I102 within the device's electrodes is maintained between the charging phase and the conductivity phase.

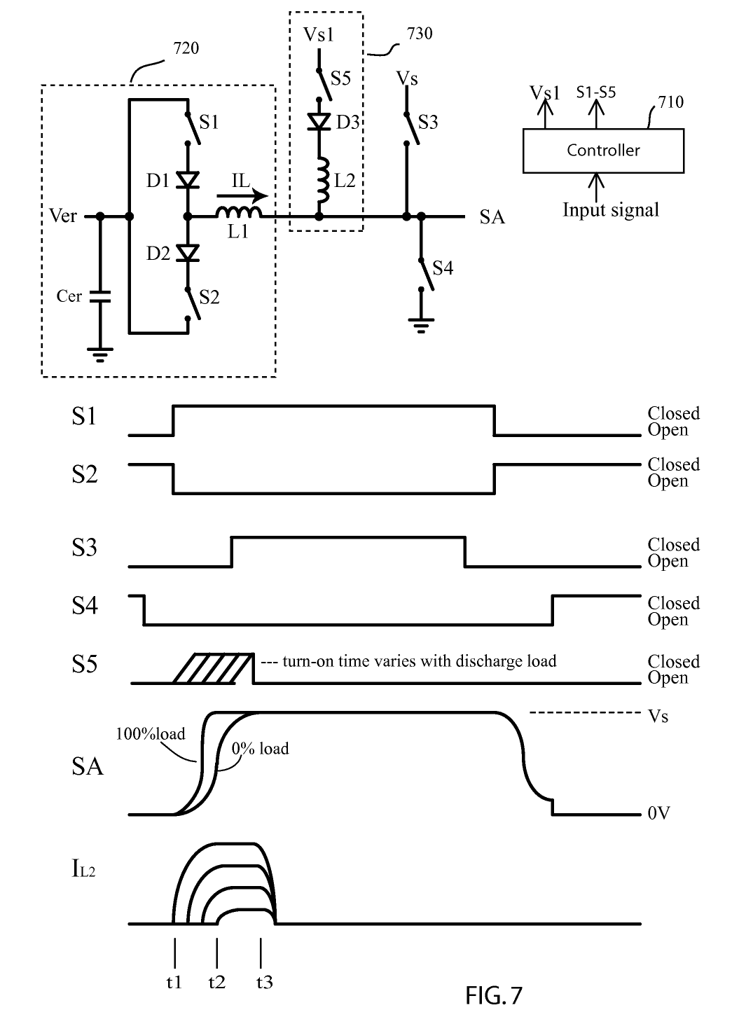

FIG. 7 illustrates a second embodiment of the invention, wherein a controller 710 receives an input signal to modulate the timing of a supplemental switching circuit 730 and/or the voltage level of voltage source Vs1. FIG. 7 illustrates a circuit and driving method wherein switch S5, diode D3 and inductor L2 are added in parallel to the existing energy recovery circuit 720 to provide additional current between the charging and conducting phases.

During the application of a rising transition, S1 is closed to begin the resonant charging phase. Switch S5 may be closed thereafter in response to the anticipated current draw as was described in FIG. 6 relative to switch S3. The voltage of voltage source Vs1, the timing of switch S5 and the inductance of inductor L2 may all be predetermined to provide zero or minimal additive current during a 0% load condition, to provide substantial additive current for the 100% load condition and proportional current sourcing therebetween. If additional current remains following the discharge, any residual current will be channeled through S3, back to the supply Vs. In a preferred embodiment of the invention, voltage Vs1 greater than voltage Ver but less than voltage Vs, so that the current flow through inductor L2 diminishes to zero prior to the falling transition of the output SA. As shown in FIG. 7, using the closing times of switches S1 and S3 for reference, under zero or minimal load, switch S5 may be closed at a time t2 to provide a small current IL2 during the application of pulse SA. For increased load, switch S5 may be closed earlier, up to time t1 to source additional current through inductor L2. The current IL2 is proportional to the amplitude of voltage across inductor L2 and the length of time a positive voltage (relative to the instantaneous electrode voltage) is applied there across. Thus, as the voltage SA increases and the load transitions into its conductivity phase, the current being sourced by inductance L2 is conducted by the breakover conduction and any additional current requirement may be sourced through switch S3.

While FIG. 7 illustrates the second terminal of inductor L2 connected to the output SA, similar operation may be attained by connecting the second terminal of inductor L2 to the node where the first terminal of inductor Ler connects to diode D1.

In another application of the embodiment, the turn-on timing of switch S5 may be fixed, and optionally coincident with the turn-on timing switch S1, while the voltage VS1 is modulated between voltage Ver and Vs dependent upon the illumination load value load.

In another application of the embodiment, the operation of switch S5 may applied to the, with the cathode of diode D3 connected to switch S5 and the voltage VS1 set to a voltage relative to ground.

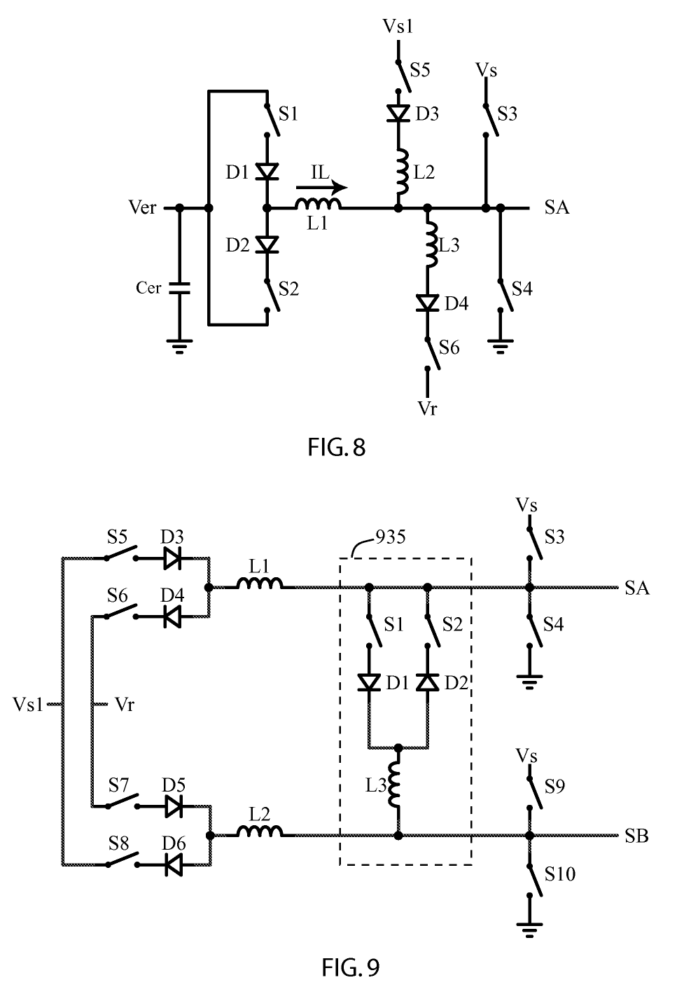

In a third embodiment shown in FIG. 8, voltage Vr, switch S6, diode D4 and inductor L3 may be operated in like fashion during falling transitions of output SA for displays having an illumination current flow on both rising and falling sustain pulse transitions.

In a fourth embodiment of the invention shown in FIG. 9, the invention is applied to a driving circuit wherein an energy recovery circuit 935 transfers capacitive energy between outputs SA and SB.

It should be noted that these embodiments may easily be applied to other common technologies such as opposed discharge, tubular, spherical, multi-electrode and other illumination and display technologies wherein a current draw occurs subsequent to applying a voltage.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A method comprising, inducing an electrode current for applying a voltage across and a current through a breakover conduction element, comprising a first current component for charging said voltage across and inducing a second current component anticipatory of said current through.

2. The method of claim 1, further comprising, receiving a signal indicative of an anticipated conduction requirement and inducing said second current component according to said conduction requirement.

3. The method of claim 2, allocating at least one time period respective of an illumination requirement wherein said conduction requirement is anticipated according said illumination requirement of said at least one time period.

4. The method of claim 3, further comprising, during said at least one time period, selecting a plurality of illumination cells comprising said breakover element, setting wall charges in said plurality of illumination cells according to said illumination requirement of said time period and inducing said first current component for charging a capacitance of said plurality of illumination cells and inducing said second current component according to a number of illumination cells bearing said wall charges.

5. The method of claim 1 further comprising, applying a first voltage to a first inductance to induce said first current component and applying a second voltage anticipatory of said current through using at least one of time and voltage modulation.

6. The method of claim 5 further comprising, conducting said second current component through a second inductance disposed along a path between a voltage source supplying said second voltage and said electrode.

7. The method of claim 1, wherein said electrode current is maintained between the charging of said voltage across and said conducting through.

8. An apparatus comprising; an electrode coupled to a cell having capacitance and a switching characteristic therein, a driving circuit for applying a pulse to said electrode, comprising a first switching circuit for inducing a first current to influence a transition time of said pulse and a second switching circuit for providing a second current to said electrode anticipatory of a current requirement of said switching characteristic.

9. The apparatus of claim 8, wherein said cell comprises a breakover conduction element comprising; at least one of: a dischargeable gas comprising at least one of helium, neon, argon, xenon, krypton, mercury and sodium; a solid-state breakover conduction device; a capacitance storing a memory state; and a light emitting element.

10. The apparatus of claim 8, further comprising a plurality of said cell coupled to said electrode, said first switching circuit comprising a first inductance for transferring capacitive energy into said plurality of said cell, said first inductance inducing an electrode current in said electrode wherein said second current substantially maintains said electrode current in said electrode according to said current requirement of said switching characteristic.

11. The apparatus of claim 8 further comprising, a controller anticipating said current requirement according to an input signal and controlling said second switching circuit according to said input signal.

12. The apparatus of claim 11, said controller further comprising a signal processing circuit for anticipating said current requirement wherein said signal processing circuit receives said input signal, determines illumination requirements according to said input signal, provides a first driving signal to said first switching circuit to induce said first current through said electrode and induces said second current according to said current requirement respective to illumination periods.

13. The apparatus of claim 12, further comprising; a matrix of illumination cells comprising said cell, said illumination cells arranged at intersections of row and column electrodes, said input signal indicative of a display image and respective to said illumination cells, said controller determining illumination cells to be illuminated in said illumination periods and, for each of said illumination period modulating said second current according to the quantity of said illumination cells to be illuminated.

14. A device comprising; a controller for receiving an input signal and driving an electrical load having first and second loading levels according to said input signal, said controller enabling a first switching circuit coupleable to said electrical load, for applying first and second pulses to said first electrode, and during said first pulse, enabling a second switching circuit according to said first loading level and subsequently, during said second pulse, enabling said second switching circuit according to said second loading level, wherein said first and second loading levels are substantially different.

15. The device of claim 14, wherein said first switching circuit comprises a first voltage source and a first transistor and said second switching circuit comprises a second voltage source and a second transistor wherein said controller enables said first transistor at a first time for influencing a transition time of said first and second pulses and enables said second transistor at second and third times according to said first and second load levels respectively, wherein said second and third times, relative to said first time, are not equal.

16. The device of claim 15, wherein said controller modulates said second voltage source to a first voltage during said first pulse and modulates said second voltage source to a second voltage during said second pulse.

17. The device of claim 15 further comprising, a second electrode capacitively coupled to said first electrode wherein said first voltage source is said second electrode.

18. The device of claim 14, wherein said first switching circuit comprises an inductance for influencing a transition time of said first and second pulses.

19. The device of claim 14, further comprising respective third and fourth switching circuits for enabling and disabling third and fourth current paths between third and fourth voltage sources and said first electrode wherein said third and fourth voltage sources have fixed potentials and timing respective to the enabling of said first transistor, and said second switching circuit comprises a second inductance for providing current according to said first and second loading levels.

20. The device of claim 19, further comprising a fifth transistor for enabling and disabling a fifth path, between a fifth voltage source and a third inductance, for providing current according to said first and second loading states.
